(19) United States
(12) Patent Application Publication
(10) Pub. No.: US 2009/0117851 A1
(43) Pub. Date: May 7, 2009

(54) QUALITY OF SERVICE SEEKER

(75) Inventor: Robert Malaney, Lindfield (AU)

Correspondence Address: SNELL & WILMER LLP (OC), 600 ANTON BOULEVARD, SUITE 1400, COSTA MESA, CA, 92626, US

(73) Assignee: NATIONAL ICT AUSTRALIA LIMITED

(21) Appl. No.: 11/573,025

(22) PCT Filed: Aug. 9, 2005
(86) PCT No.: PCT/AU05/01189

§ 371 Date: Jan. 31, 2007

(30) Foreign Application Priority Data
Aug. 11, 2004 (AU) 2004904540
May 31, 2005 (AU) 2005902804

(51) Int. Cl. H04B 17/00

(52) U.S. Cl. 455/67.11; 455/550.1

(57) ABSTRACT

This invention concerns quality of service (QoS) mapping in wireless space. QoS maps represent measurements, or predictions, of one or more quality of service metrics in the space. The maps are useful in the management of wireless communications systems. The map is comprised of several layers of information visit e at the same time. The a first layer shows the physical features within the space. Additional layers indicate the value of respective quality of service metrics at locations indicated by the first layer. Users of the communication network can contract with the service provider to have the selected services provided at respective selected service levels by using the map.

### TECHNICAL FIELD

This invention concerns quality of service (QoS) mapping in wireless space. QoS maps represent measurements, or predictions, of one or more quality of service metrics in the wireless space. The maps are useful in the management of wireless communications systems.

### BACKGROUND ART

QoS is important to users of mobile wireless devices because there are a range of physical and environmental factors that affect wireless transmissions. Cell phones generally display a single metric, signal strength, icon to the user, which appears as a series of vertical bars of increasing height. When signal strength is low only one short bar may be shown, but when signal strength is high all the bars can be seen. This icon can be used to prompt the user to move to a new location when signal strength is low. For instance, when a user is inside and wishes to make a call and the icon indicates a low signal strength, the user may use their experience to choose to move outside before initiating the call.

Cell phones originally provided only telephone services. More recently other communications services can be provided, such as SMS and WAP. Data services are also available including voice over data (VoIP), images and video transmissions. Service levels can be defined for each of these services, for instance in terms of the value of one or more QoS metrics of the communications channel by which the service is provided. A service level can also be defined in terms of the priority, or preference, which will be given to allocation of resources to a particular channel.

### DISCLOSURE OF INVENTION

In one aspect the invention is a quality of service map for a wireless network. The map comprises several layers of information visible at the same time. A first layer is a diagram showing physical features within the space where communications are provided by a service provider. Additional layers indicate the value of respective quality of service metrics at locations indicated by the first layer. Users of mobile wireless devices within the network contract with the service provider to have one or more selected communications services delivered to the mobile device. The users also contract with the service provider to have the selected services provided at respective selected service levels. The service provider, or the user, or both, use information from the map to enable provision of the selected communications services at the respective selected service levels.

QoS metrics may include, but are not limited to:

availability of a connection;

goodness of a connection;

received signal strength;

packet loss;

bandwidth;

throughput;

packet delays;

packet errors reported;

coherence time of the channel; and

variability of the channel.

Alternatively, a QoS metric may comprise a more than one, or a combination of such metrics.

A QoS metric may be comprise a statistically derived value from any of the metrics outlined above. For instance, a mean, median, maximum, minimum, last reported value, or a combination or weighted combination of such data, taken over an area, volume or time period.

A QoS metric may be comprise any of the metrics outlined above, but which additionally has been weighted according to one or more user selected preferences.

A user may select a service to be provided at a service level represented by a QoS metric or by comparison to a QoS metric.

A user selected QoS level may be related to the quality of communications channels provided to the user, for instance a user may select to have voice communications at or above a given signal to noise ratio. The metrics related to quality of a communications channel may be represented as one or more layers of the map.

A selected communications service may require delivery of one or more preferential, “priority”, quality communications channels to the mobile. The preferential quality may involve the delivery of different quality communications channels to different types of communications traffic content to the mobile. Alternatively, the preferential quality may involve the delivery of different quality communications channels to different applications running on the mobile device. A preferential QoS map may be constructed by calculation from the collected best effort measurements, or by direct measurements from users using the service; or combination of both.

The service provider may adjust the service metrics of a communications channel from time to time to maintain the quality of a communications channel. The service provider may automatically adjust the service metrics to take account of changing factors that impact the quality of that communications channel. The service metrics may be automatically adjusted during a communication to maintain that communication, or the quality of that communication, in the face of changing factors that impact the quality of that communication. The service metrics may be automatically adjusted at the expense of other communications channels.

The metrics themselves may be current, or predicted.

The payments required from the user for the communications services may vary depending on the quality selected. The payments may vary depending upon the quality provided.

There may be a data communications channel and a preferential voice over IP (VoIP) channel that is always given preference over the data channel.

In a further aspect there is a mobile wireless device for use in a wireless network. The device comprises a memory in which a quality of service map for the wireless network is persistently stored. The map comprises several layers of information visible at the same time: a first layer is a diagram showing physical features within the space where communications are provided by a service provider, and additional layers indicate the value of respective quality of service metrics at locations indicated by the first layer. The user contracts with the communications service provider to have a selected level of communications services delivered to the mobile device. And, the user receives information from the map to enable provision of the selected level of communications services.

The quality of service map may be embedded in software access protocols of the mobile device.

The transmissions may be periodically received to update the map.

The selected communications services may require delivery of specified values for specified metrics.

The user may receive information from the map to move in the space in a manner consistent with provision of the selected service levels.

The current location of the mobile wireless device may be determined using automated location technologies and displayed on the map.

The mobile wireless device may collect information on quality of service metrics within the coverage area, and this information may be used to update the quality of service map. The mobile wireless device may also communicate the collected information to a base station.

The device may communicate with different applications run on different devices of a personal area network (PAN) carried by the user.

In further aspects the invention may be presented as a computer server to create and transmit a quality of service map. The server may utilize machine learning techniques or statistical analysis of the data are used to create the map. The server may also operate to receive information about at least one quality of service metric from mobile wireless devices in a wireless network, and to update the quality of service map using the received information. The server may also operate to communicate updated QoS maps to the mobile wireless devices.

The invention may be presented as a system comprising a server, a wireless network and a plural number of mobile wireless devices as described above.

The invention may also be presented as a software program installed on a mobile wireless device to receive a quality of service map and communicate indications from them to the users, as described above.

Further, the invention may be a method for providing a quality of service map to a mobile wireless device comprising the steps of:

Receiving and storing information about at least one quality of service metric from mobile wireless devices at multiple locations within a wireless network coverage area.

Creating and storing the map from the stored information.

Transmitting the QoS map to mobile wireless devices in the coverage area of the network.

The step of creating a quality of service map may be performed by a processor 35 that applies machine learning techniques to the stored information to determine the quality of service at locations within the coverage area where a quality of service measurement is not stored

### BRIEF DESCRIPTION OF DRAWINGS

Examples of the invention, “QoS Seeker”, will now be, described with reference to the accompanying drawings, in which:

FIG. 1 is a schematic diagram of a wireless network.

FIG. 2 is flowchart depicting QoS Seeker as used by a mobile device.

FIG. 3 is flowchart depicting the collection of QoS metrics from mobile devices.

FIG. 4 is a flowchart depicting the construction of a QoS map.

FIG. 5 is a 2-Dimensional representation of a 3-Dimensional QoS map based on one QoS metric.

FIG. 6 is a schematic representation of a QoS map.

FIG. 7 is a schematic representation of another QoS map.

FIG. 8 is a diagram of a basic neural network used in predicting QoS maps.

FIG. 9(a), (b) and (c) are a series of graphs of neural network prediction of RSS (received signal strength) in a QoS map.

### BEST MODES FOR CARRYING OUT THE INVENTION

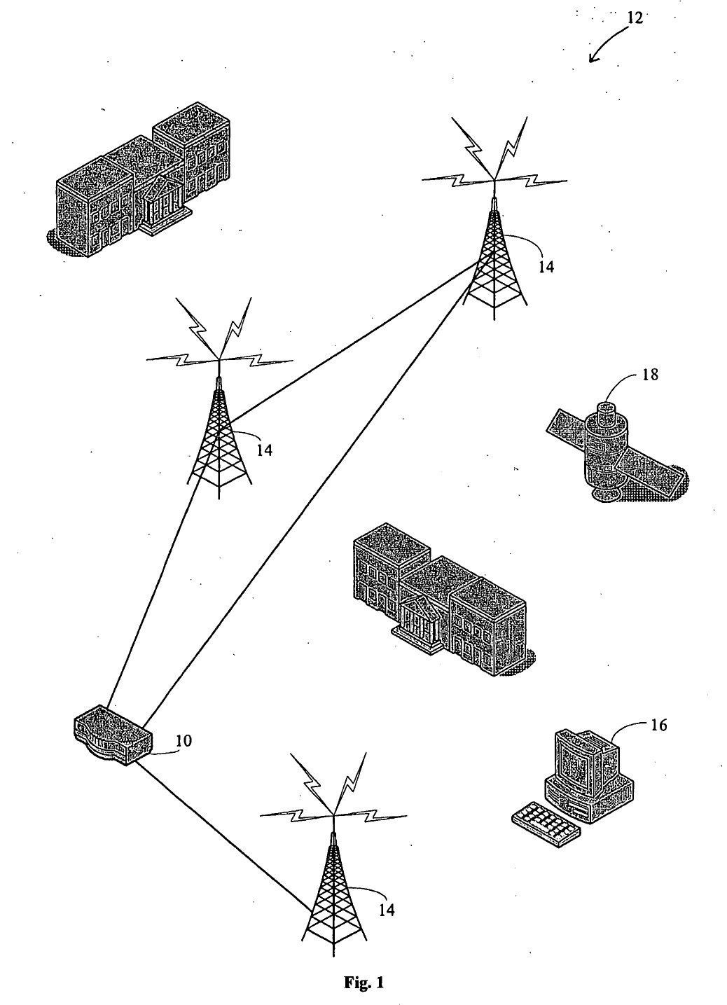

Referring first to FIG. 1, a typical wireless network arrangement incorporating the invention will be described: A QoS map server 10 is associated with a wireless network 12 having a known geographic area of coverage, such as a university campus. Server 10 generates and stores a QoS map involving variations in a number of service metrics across the area of coverage. Transceivers 14 communicate over the network 12 with the QoS map server 10 and wirelessly with mobile wireless devices 16 of users in the coverage area.

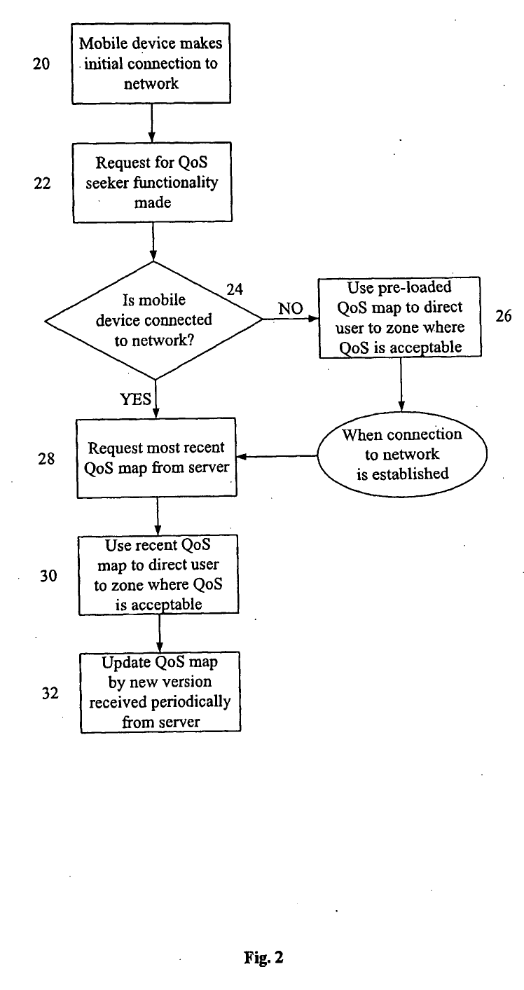

The mobile devices 16 are mobile phones, PDAs, notebook computers or any wireless communications devices. These devices communicate over a wireless network which is able to provide a number of different service levels. Referring now to FIG. 2, when a mobile device first makes contact with a network 20 supporting QoS Seeker technology they are able to request particular service levels for chosen applications and download the QoS map functionality 22. Payment may be required and made in any conventional fashion. A QoS map is transmitted to the device and loaded. When next the device attempts to connect to the network, if connection cannot be made 24 the preloaded map may be used to direct the user to a zone where QoS is at or above the selected service levels 26. An updated QoS map may be requested once a connection is established 28. This map will also serve to direct the user to zones where QoS is at or above the selected service levels 30. While the mobile device remains in contact more updated QoS maps will be periodically received 32.

It is important that the QoS maps remain updated. Actual collection of QoS metrics can be achieved by several means. At the lower layers the received signal strength can be automatically collected by wireless network devices. At the higher layers QoS metrics can be obtained by utilising applications such as RTP—an Internet based protocol for the transport of real time data including audio and VoIP. Error statistics can be determined from information in the Real Time Control Packets (RTCP). Note also, that the correlation of such QoS metrics with each other may also be used. For example, when received signal strength data is available but no packet losses measurements are available, historical correlations of packet loss with received signal strength may be used to predict packet loss for a specific application in a specific location. In physical locations where there are no measurements at all, propagation models could be deployed in order to predict the received signal strength at a given location. The mobile devices 16 may themselves be used to update the QoS maps as described above. This method of updating also naturally optimises the QoS maps in the areas where there are most users, since accuracy is increased where the density of users is highest.

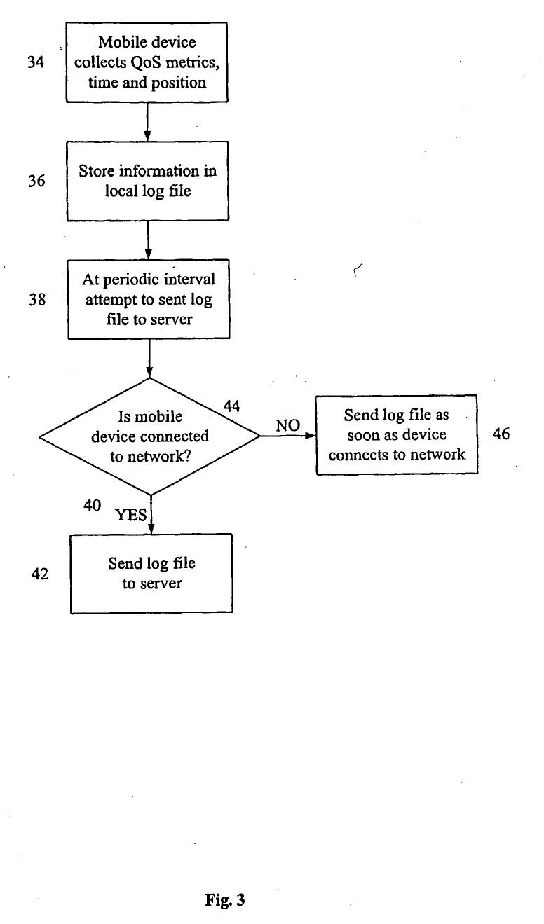

Referring now to FIG. 3, a method for updating a QoS map using mobile devices 16 will be described. First, mobile devices 16 having embedded GPS capability collect coarse metric measurements from determined locations over the campus area 34 and store it in a local log file 36. The mobile device attempts to transmit this information back to the server at periodic intervals 38. Provided the mobile device is in contact with the network 40 the transmission proceeds 42. In the event the device 16 is not connected to the network when the transmission time arrives 44, the information is transmitted when the device next connects to the network 46.

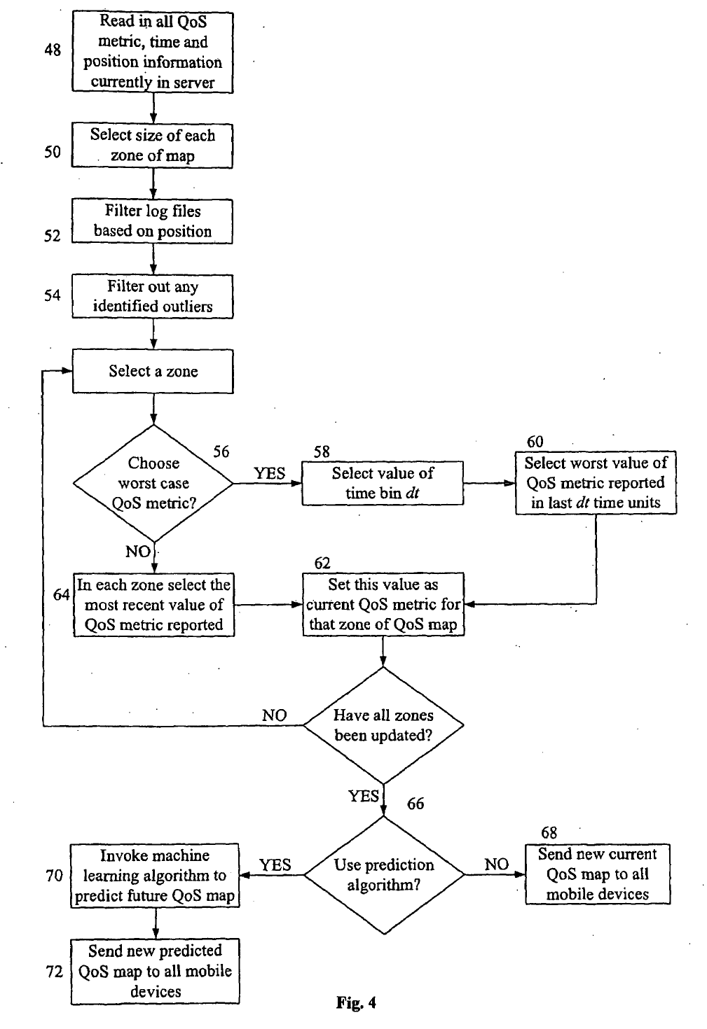

Referring now to FIG. 4, a method of constructing a QoS map will now be described. First, all the QoS metric data and related time and position data currently stored at the server are read 48. The map is divided into geographic zones with the size of each zone being selected 50 depending on the granularity required. The data log files are then filtered depending on their position 52. Outliers are then filtered out 54.

For each zone the following steps are then repeated: The worst case metric is selected 56, the data in the most recent time bin 58 are selected, and the worst value of the metric in this bin is selected 60. This value is set to be the current QoS metric for that zone of the QoS map 62. Alternatively, if there is no data in the most recent time bin the most recent value of the QoS metric is selected 64, and this value is set at step 62.

Once all the zones have been updated 66 the new current QoS map can be sent to the mobile devices connected to the network 68. Alternatively, machine learning may be used to predict a future map 70, and the future map may be sent to the mobile devices 72.

For instance, ambient measurements of packet loses correlated with received signal strength can be used to produce a QoS vs. signal strength model. The known positions of the mobile devices can then be used to determine a propagation model.

A predicted future QoS map may then be produced. Machine learning techniques are then used at the server to generate a detailed predicted QoS map over the campus area. For instance, the measurements already mentioned, packet losses correlated with received signal strength, can be combined with an ambient mathematical model to predict voice QoS across the campus. This map will be continually updated by new data.

The resulting QoS map is then transmitted back from the server to mobile devices currently in contact. The received QoS maps are loaded into the mobile devices. The mobile devices use the loaded map to indicate the variations of the QoS voice metric represented in vicinity of the user to the user. The user then interprets this indication and, as a result they may decide to move to improve their QoS.

The indication from the mobile device to the user may be direct, for instance by displaying the map superimposed over a map of the campus to the user. The user can interpret this display to move to a location where the voice channel is good before making a call. Alternatively, the indication could be a voice announcement to the user suggesting that better reception can be obtained by walking ten paces north, or to the corner of the building.

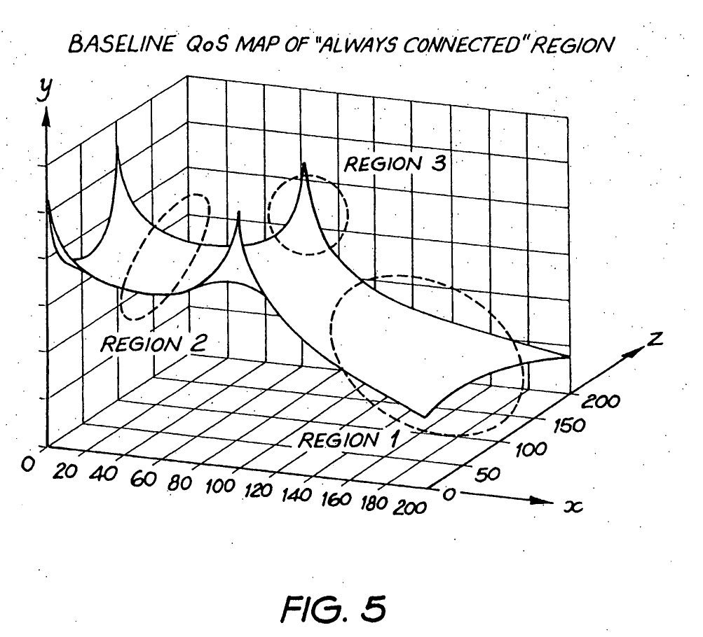

A QoS map could indicate to the user the quality of the connection that will be obtained from their current location. FIG. 5 shows a schematic QoS map based on the QoS metric: packet loss. The x and z axes represent a 2-dimensional representation of the area covered by the QoS map, and the y-axis represents the packet loss. Three regions on the QoS map are identified. If the location of the user, as determined using GPS, was in Region 1 the map would indicate that a connection from that location would have a 10% packet loss; which is a bad connection. If the user was in Region 2 the map would indicate that a connection from that location would have a 3% packet loss; which is an acceptable connection. If the user was in Region 3 the map would indicate to them that a connection from that location would have a 1% packet loss; which is a good connection.

In addition to information about the QoS of their current location, the variation of the QoS throughout the vicinity around that location is also indicated to the user. If the user was in Region 1, the map would indicate that a better connection could be obtained by moving either to Region 2 or 3. Information on how to get there would also be provided. For instance, the different regions could be colour coded and shaded on top of a geographical map of the user's vicinity, which displayed features such as streets and buildings. In this way the user can make an informed decision on where they could move in order to improve their QoS. Similarly, if the user was in Region 2, the map would indicate that a better connection could be obtained from Region 3. Again information about how to get there would also be provided.

The QoS map could be more complex to account for several different QoS metrics. Such a QoS map could display a series of layered surfaces, each representing a different metric. The layers could also be combined into a single displayed layer.

The QoS requirements need not be the same for different applications running concurrently on the user's mobile. This would result in different QoS maps being used by the different applications to indicate their QoS in the user's vicinity. In addition, different priorities may be specified by the user for different applications, and these can also be taken into account in the displayed maps. Such maps can be seamlessly embedded within the software and access protocols of the user's mobile device.

In the event that the user moves to an area where the QoS requirements of all the applications are not met, the actual QoS of their location can be determined using the QoS map. Embedded software in the mobile device could then automatically allocate communications to services to higher priority applications.

The QoS maps may also indicate to the user places not to go in order to maintain their connection. This is particularly important for a mobile device that is running mission-critical applications such as health monitoring. Alternatively, it may also be indicated to the user which of their applications will sustain satisfactory QoS connections if they do move to a location with a lower QoS measurement.

An indication can be made to the user to identify a ‘hot spot’, that is the location that will provide the optimal QoS for their applications.

### Detailed Implementation of OoS Seeker Technology.

In actual implementation the QoS map can be considered in abstract terms as a matrix Qᵢⱼ of dimensions i by j. The element of this matrix corresponds to a particular physical zone of the QoS map. Without loss of generality we will assume all elements of the matrix represent a physical zone of equal area. Consider a vector of QoS metrics \vec{q}. The elements of this vector will contain any information obtained by the receiver which could pertain to the QoS of a specific application. For example, for a real-time video connection, these metrics could be the packet delays, packet losses, jitter, received signal strength (RSS) and data throughput (DT), amongst others. The GPS coordinates and GPS time will also be included in the \vec{q} vector. (If GPS is not used the local clock time and position coordinates determined by any positioning technology can be used.) Note that for privacy reasons no information on the actual wireless device which could identify the user (such as Mac, address IP address) will be used by the server.

Consider there are N users currently located within the area defined by the QoS map. Then, there will then be N users periodically reporting their \vec{q} vector back to the QoS map server. The QoS map server must use this data to create QoS maps for each application running in the system. The QoS map may be created based on only one QoS metric within the \vec{q} vector, or it may be based on some combination of QoS metrics.

Data Throughput QoS Map

QoS Seeker technology can be enabled over any wireless networks (such as WLAN, Bluetooth, GSM, 3G, 4G) either indoors or outdoors, using any QoS metric. However, in order to bring some focus to our discussion, let us consider a simple outdoor example where the data throughput (DT) reported by a WLAN card is the single QoS metric under consideration. Access points can normally degrade the design DT as the quality of the Radio Frequency (RF) signal degrades—and report the new design DT to the receiver. Normally the card can report DT as 11 mbs, 5.5 mbs, 2 mbs, 1 mbs. For no connection we designate the DT as 0 mbs. We can classify these values as Excellent (E), Good (G), Acceptable (A), Poor (P), and Bad (B), respectively. As the users move around the QoS map area the value of DT is recorded along with the GPS position coordinates and GPS time. This data is collected into a log file on the user's system. Periodically this information is sent to the QoS map server (if the information cannot be sent to server due lack of connection to the network, then it is sent as soon as the user can access the network).

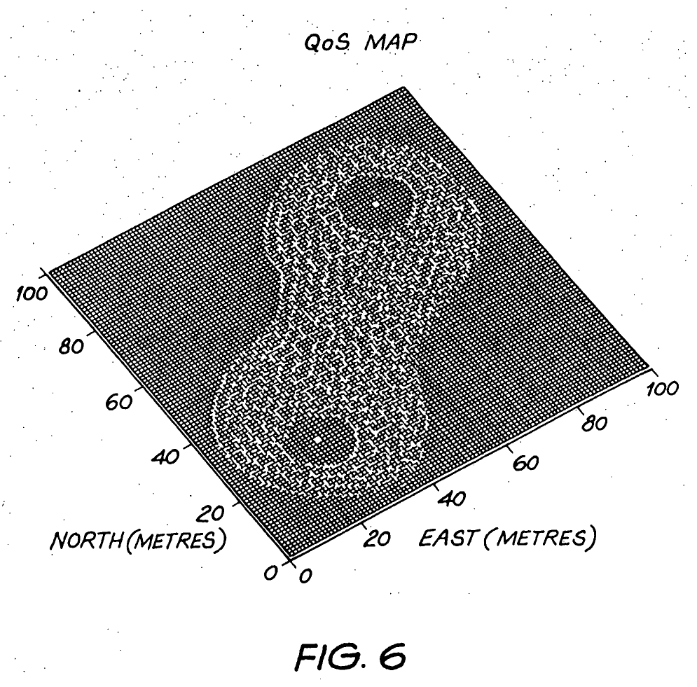

FIG. 6 is an example of a QoS map shaded to represent the actual DT values. DT for 11 mbs (E Area) can be found in the vicinity of the two spots, and the DT values degrades as we move away from these two spots.

The resolution shown here (1 m) is likely not required in most outdoor situations. We will normally construct a lower resolution map of typically 5-10 m. Our task is to construct QoS maps, such as that shown below, on an ongoing basis from the data that is being sent to the server from all users in the system. These users will be periodically updated with the new QoS map, which is seamlessly embedded in their own QoS map user interface—the interface which helps them navigate to the best QoS areas.

### The Current QoS Map

Our first test case will be a system which creates the current QoS map. That is, we will just use the available data within the server to construct a QoS map representing the current conditions. This QoS map will not take into account any historical data, nor will it try and predict the QoS map for the future epochs. Let us consider sequentially each zone of the QoS map (corresponding to a specific Qᵢⱼ). This is done by filtering the database so that data with GPS coordinates lying within the area represented by Qᵢⱼ is selected. To construct the current QoS map the server will inspect all of the DT values in each QoS zone and pick the most recent DT value as the current DT value for that area. Repeating this for each area will provide the most up-to-date QoS map. This updated QoS map is then sent back to all users of the system.

### The Dynamic QoS Map

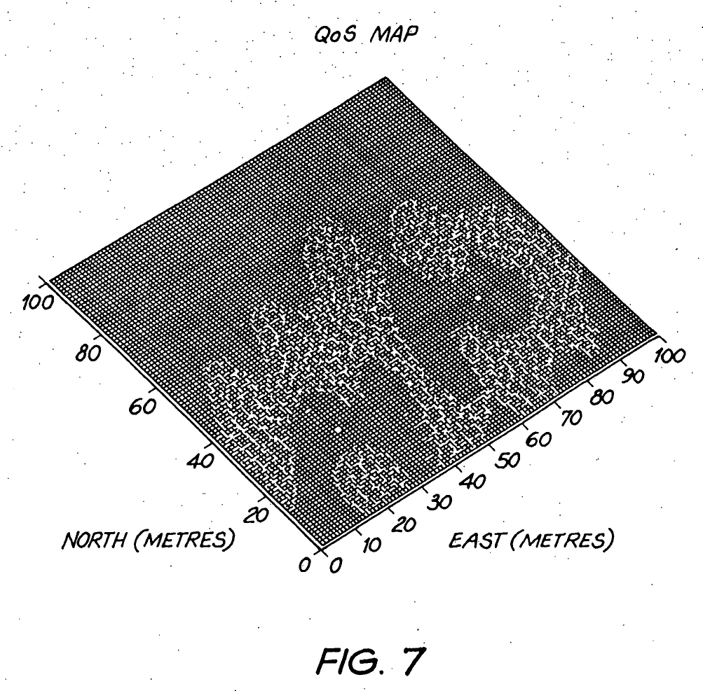

This is a more sophisticated case where the current QoS map and historical QoS maps are combined in order to predict the future QoS map for the next epoch. This is important in dynamic situations where the current QoS map may not be indicative of what is likely to happen in the near future. Our principal aim here to avoid sending a user to a (currently) good area, only for him to find when he gets there the area is now bad. For example, the QoS map illustrated in FIG. 6, may after some time interval evolve to that shown in FIG. 7. A production wireless network and the QoS maps describing them are complex, and there are many reasons why such dynamic alterations in the QoS map, such as that shown, can occur. In order to improve upon the usefulness of QoS maps we must attempt to model dynamic behaviour of QoS maps in some coherent fashion.

The question we face is given the data currently in the server: what is the best estimate of the value of Qᵢⱼ (corresponding to specific zone of the QoS map) at some future epoch?

### Neural Networks

The predicted value will represent the predicted QoS classification for that specific area for the next epoch. Analysing each zone will collectively lead to the predicted QoS map for the next epoch. The prediction of the next QoS map will be based on a Time Delay Neural Network (TDNN). Various TDNN architectures have been previously used in many applications, the most significant ones being stock market prediction and speech recognition. Their advantage over traditional prediction schemes lies in their flexibility, and their ability to model complex, non-linear time series. TDNN operate by using a series of test data as training vectors for the network. Once trained, previous inputs can then be used to successfully predict the next output. The TDNN network can also be made to self-adapt to ongoing data collection (re-training). All these characteristics make them ideal for the potentially complex and dynamic behaviour that underpins QoS maps.

Given a series of n past measurements for a given Qᵢⱼ the TDNN is employed to predict the next value of Qᵢⱼ. In the limit of a static QoS map environment, this procedure will deliver the same performance as the Current QoS map procedure outlined earlier. However, in a dynamic situation with hidden temporal trends, the use of TDNN will lead to performance gains. For these reasons adaptive TDNNs are embedded within our QoS map system.

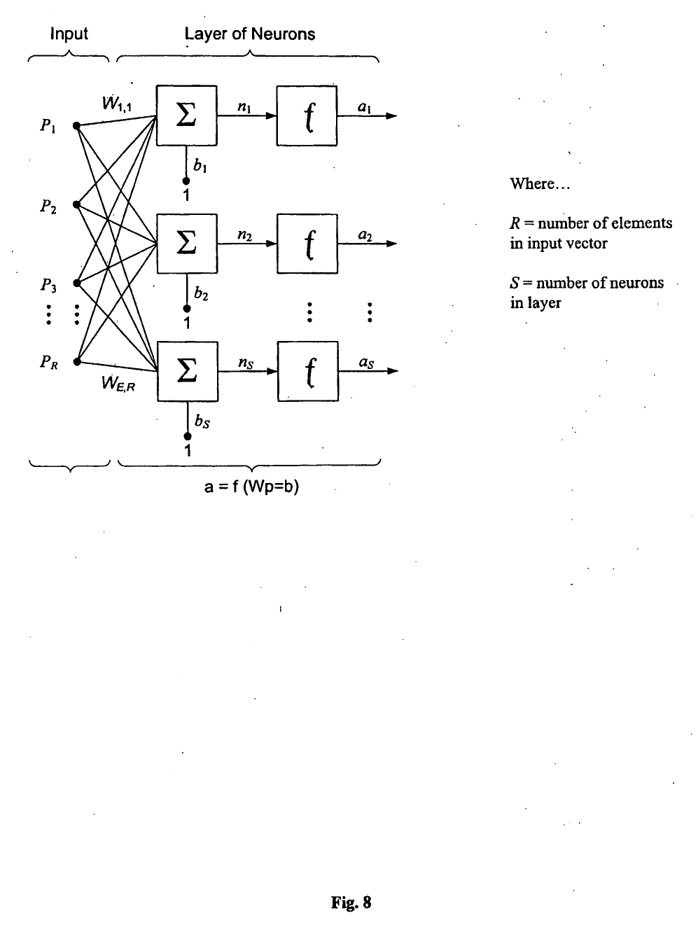

Determination of the appropriate network architecture (number of layers, number of neurons, type of transfer functions) to use for a given QoS map requires experimentation. A specific architecture is unlikely to be optimal for all QoS metrics at all times. However, in general in the QoS map server the architecture of the neural networks will be based on Multi-Layer Perceptron (MLP) models. These type of networks are also known as feed-forward networks. A generic architecture of such models is shown in FIG. 8 below (taken from Mathworks.com). In the QoS map server the inputs p₁, p₂ . . . p_{R} will represent time delayed inputs representing historical values of the QoS map metrics. Although in general we can consider the input pᵢ as a vector (each element of which represents different zones of the QoS map), to simplify matters we will assume each pᵢ to be scalar. The time delayed values of pᵢ collectively form the input vector \vec{p}=p₁, p₂ . . . p_{R}. These correspond to a series of historical values of a specific QoS metric vector at a specific zone (corresponding to a specific Qᵢⱼ) of the QoS map. For each QoS metric at each zone we form a specific TDNN.

In this network, each element of the input vector \vec{p} is connected to each neuron input through a matrix of weights W. Each neuron sums the weighted inputs and a bias term to form its own scalar output which is then collectively acted upon by a transfer function to produce the output a. This transfer function can take various forms, with linear and log-sigmoid functions the most common. The output a can be taken as input into another layer of neurons, and the process repeated. This layer of neurons is termed a hidden layer. Finally at the output layer the final inputs are combined in a linear way to give the final prediction. The number of neurons at each layer, the number of layers, and the adopted transfer functions collectively describe the neural network architecture. In the QoS map server the actual architecture adopted could be different for different QoS metrics. A model based on FIG. 8 but with one hidden layer, one neuron, and a linear transfer function will lead to an optimized adaptive linear filter, and in some cases such a simple architecture will suffice.

### TDDN Simulation of RSS

The RSS metric is one of the most important elements of the QoS \vec{q} vector. There are several reasons for this. First, it is one of the metrics that will be device independent. Other QoS metrics, packet delay for example, measured at the application layer are to some extent (albeit in a minor fashion in most circumstances) influenced by the processing load currently active on a device. Secondly, even when a device is not running an application it can still be recording RSS measurements within the QoS map area. Thirdly, historical correlations with other QoS metrics and the RSS can be used to predict future metrics in a zone where no previous QoS metrics have been measured.

Due to the importance of the RSS we present below some simulations in which a TDDN is employed in order to predict the value of the RSS at the next epoch. Here we will see the usefulness of the adaptive machine learning technique in delivering significant performance gains relative to using the current QoS map as a measure of the next epoch QoS map.

Again we will focus on one zone of the QoS map (corresponding to a specific Qᵢⱼ). The procedure outlined below is repeated for every zone. In these simulations the RSS has been modelled via a log-normal shadowing model for the path loss which can be written

$$P L ( d ) ( dB ) = \overline{P L} ( {d}_{0} ) + 10 n {log}_{10} ( \frac{d}{{d}_{0}} ) + {σ}_{db} , \qquad ( 0.1 )$$

where d is the distance from the transmitter, do is a reference distance, n is the path-loss exponent, and σ_{db} is the standard deviation of the shadowing in dB.
The path loss can be explicitly written in term of the received power level Pᵣ(dBm) (the RSS) and the transmitted power Pₜ(dBm) through

PL(dB)=Pₜ(dBm)−Pᵣ(d)(dBm). (0.2)

In the neural network calculations it will be useful to normalize the value of the RSS to one (as the actual RSS is in negative dBm the smallest value of the RSS present in the simulation is equal to 1). In the example shown we consider the case where the average of 10 sequential RSS measurements are sent periodically from the device to the QoS map server. In the QoS map zone considered we assume n=3, σ_{db}=6 and d=20 m. A slowly evolving increase in the normalized RSS was added to mimic QoS map evolution. For this simulation we will assume the data reported does not contain any gaps.

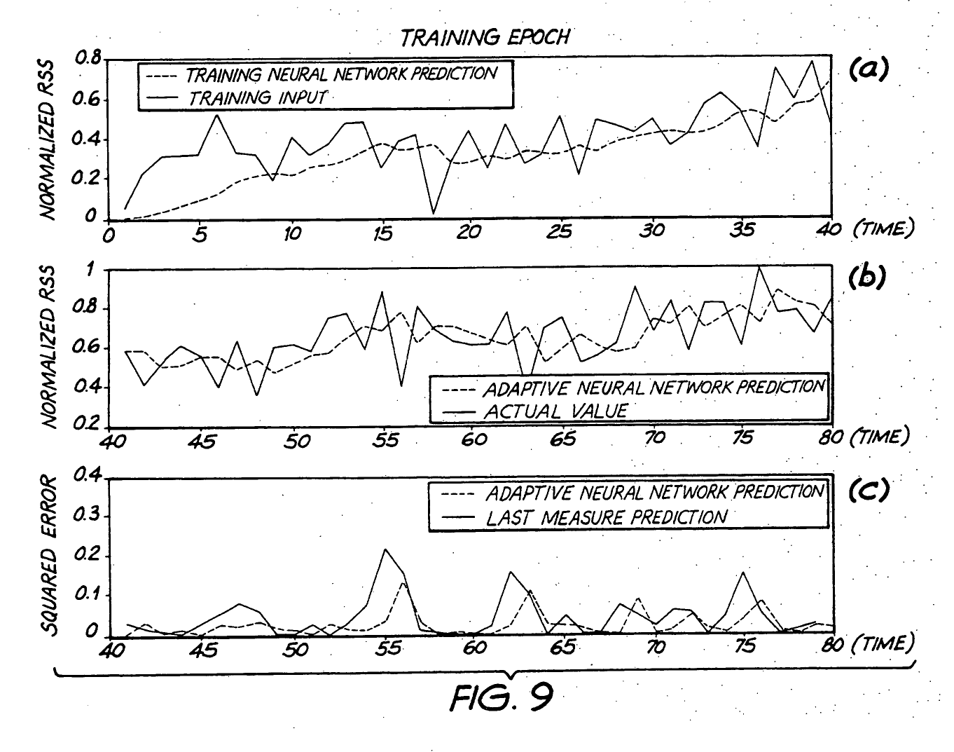

The number of previous reported RSS measurement to be chosen as the inputs to the TDNN is dependent on several factors. In this simulation we will use the previous four reported RSS values in an attempt to predict the next RSS value. FIG. 9(a) represents the training epoch of the neural network. Here the first 40 samples of the reported RSS data are used to train the network. We can see that the network becomes trained quite quickly. In FIG. 9(b) we show how the neural network adaptively learns as it evolves. Each new incoming measurement is used to adaptively re-train the network. This allows the network to-readjust if the evolving trend of the measurements change in any significant way. The dashed curve of this diagram again shows the predicted value of the RSS and the solid line shows the actual reported value. Perhaps more illuminating is FIG. 9(c). Here the squared error is shown. The dashed curve represents the squared error between the neural network prediction and the actual value, and the solid curve shows the same error if the previous RSS value is simply adopted as the predicted next RSS value (that is using the current QoS map as indicator of the future QoS). The neural network predictor is seen to show significant performance gain. More quantitatively, we find for this simulation the mean squared error of the neural network predictor is twice that of the simple predictor—a performance gain we found for many similar simulations using different propagation model parameters.

The model we have used here for the evolution of the RSS in the simulation was in fact a linear one. In this case the neural network behaves like an optimized adaptive linear filter. Even larger performance gains could be anticipated in the case on non-linear behaviour. The neural network architectures embedded in the QoS map server are designed to seamlessly handle any non-linear behaviour it encounters.

The use of adaptive linear filters is a means to predict future QoS Maps from historical QoS Maps. By using the RSS as the QoS metric, we show that local adaptive filters can deliver significant performance gains relative to last-measure and moving-average predictors. Even under the mild evolution conditions we have found up to 70% performance gains. Such gains have important impact on the functionality of QoS Maps.

We have also investigated the trade off between using global adaptive filters over all the QoS Map space, relative to local filters individually optimized for their specific zone. We find that a relative gain of order 20% is achieved by using local filters.

### Other QoS Map Metrics

The QoS map we have outlined for data throughput (DT) is useful largely in the context of obtaining a connection to an access point within a WLAN. The QoS maps based on RSS are useful when no history of the specific QoS metric required is available. However, many other QoS metrics are potentially available to the QoS map server. For example, packet delay is likely useful when we consider a real-time video connection between two users in the WLAN. In principal we can use the same procedures, as outlined above, for other elements of the QoS metric q vector. However, minor differences to our algorithms may be useful for metrics such as packet delay. For example, we may wish to use the largest packet delay reported in last time bin, as the indicator of the current QoS. Selecting the worst case is a better way of delivering a more reliable prediction system to new users who may enter an area in some future epoch.

A similar system and method can be outlined for an indoor wireless system. Unlike the outdoor systems, GPS may not be suitable for determining the location of a user indoors. Instead, any other positioning information, such as Wireless Local Area Networks (WLANs), may be used to determine user positions. In smaller indoor environments such as office blocks, QoS could also be measured by ambient devices at fixed locations, in addition to roaming ambient devices. Other than this, indoor systems work in a similar fashion to outdoor systems.

A QoS map may not only be dependent on the location of the sender, but also on the location of the receiver. For example, a VoIP a connection between two hosts within a WLAN environment could be dependent on the location of both users. A physical area is broken into multiple QoS settings. For example, a QoS map could indicate to a user that a certain physical area is good if the end connection is 1 km due south, but bad if the end connection is 1 km due north. This functionality could also be embedded within the QoS map.

The mobile device may use a different embedded location technology other than GPS or WLAN positioning systems, or it may use different combinations of different positioning systems.

More than one QoS map server may be connected to a network. Each QoS map server may then be responsible for determining the QoS map for their immediate environment.

QoS Seeker technology can also be used in a mode where no QoS server is part of the design. In this mode the wireless device itself creates it own QoS map based on its own historical and ongoing QoS measurements, and internal predictions and calculations. This information is again relayed to the user in order to inform them of QoS metrics in their vicinity. In this mode QoS Seeker technology will have additional privacy protection.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A quality of service map for a wireless network, the map comprising several layers of information visible at the same time, a first layer is a diagram showing physical features within the space where communications are provided by a service provider, additional layers indicate the value of respective quality of service metrics at locations indicated by the first layer; wherein, users of mobile wireless devices within the network contract with the service provider to have one or more selected communications services delivered to the mobile device; wherein the users also contract with the service provider to have the selected services provided at respective selected service levels; and wherein, the service provider, or the user, or both, use information from the map to enable provision of the selected communications services at the respective selected service levels.

2. A quality of service map according to claim 1, wherein the quality of service metrics include one or more of:
availability of a connection;
goodness of a connection;
received signal strength;
packet loss;
bandwidth;
throughput;
packet delays;
packet errors reported;
coherence time of the channel;
variability of the channel;
more than one of the above metrics;
a combination of the above metrics;
a statistically derived value from any of the above metrics any of the above metrics which has been weighted according to one or more user selected preferences.

3. A quality of service map according to claim 1 wherein the user selects a communications service to be provided at a service level represented by a QoS metric.

4. A quality of service map according to claim 3, wherein metric is related to the quality of a communications channel are represented as one or more layers of the map.

5. A quality of service map according to claim 3 wherein the selected communications service requires delivery of one or more preferential quality communications channels to the mobile.

6. A quality of service map according to claim 5, wherein the preferential quality involves the delivery of different quality communications channels to different types of communications traffic content to the mobile.

7. A quality of service map according to claim 5, wherein the preferential quality involves the delivery of different quality communications channels to different applications running on the mobile device.

8. A quality of service map according to claim 5 wherein the service provider adjusts the service metrics of a communications channel from time to time to maintain the quality of a communications channel.

9. A quality of service map according to claim 8, wherein the service provider automatically adjusts the service metrics to take account of changing factors that impact the quality of that communications channel.

10. A quality of service map according to claim 9, wherein the service metrics are automatically adjusted during a communication to maintain that communication, or the quality of that communication, in the face of changing factors that impact the quality of that communication.

11. A quality of service map according to claim 10, wherein the service metrics are automatically adjusted at the expense of other communications channels.

12. A quality of service map according to claim 2, wherein the metrics are current.

13. A quality of service map according to claim 2, wherein the metrics predicts future values.

14. A quality of service map according to claim 3, wherein payments required from the user for the communications services vary depending on the quality selected.

15. A quality of service map according to claim 3, wherein payments required from the user for the communications services vary depending upon the quality provided.

16. A quality of service map according to claim 5, wherein there is a data communications channel and a preferential voice over IP (VoIP) channel that is always given preference over the data channel.

17. A mobile wireless device for use in a wireless network, comprising a memory in which a quality of service map for the wireless network is persistently stored, the map comprises several layers of information visible at the same time, a first layer is a diagram showing physical features within the space where communications are provided by a service provider, additional layers indicate the value of respective quality of service metrics at locations indicated by the first layer; wherein, the user contracts with the communications service provider to have a selected level of communications services delivered to the mobile device, and wherein the user receives information from the map to enable provision of the selected level of communications services.

18. A mobile wireless device according to claim 17, wherein the quality of service map is embedded in software access protocols of the mobile device.

19. A mobile wireless device according to claim 17, wherein transmissions are periodically received to update the map.

20. A mobile wireless device according to claim 17 wherein the selected communications services require delivery of specified values for specified metrics.

21. A mobile wireless device according to claim 17, wherein the user receives information from the map to move in the space in a manner consistent with provision of the selected service levels.

22. A mobile wireless device according to claim 17, wherein the current location of the mobile wireless device is determined using automated location technologies and displayed on the map.

23. A mobile wireless device according to claim 17, wherein the mobile wireless device collects information on quality of service metrics within the coverage area, and this information is used to update the quality of service map.

24. A mobile wireless device according to claim 23, wherein the mobile wireless device also communicates the collected information to a base station.

25. A mobile wireless device according to claim 17, wherein the device communicates with different applications run on different devices of a personal area network (PAN) carried by the user.

26. A computer server to create and transmit a quality of service map according to claim 1.

27. A computer server according to claim 26, wherein machine learning techniques or statistical analysis of the data are used to create the map.

28. A computer server according to claim 26, wherein the server also operates to receive information about at least one quality of service metric from mobile wireless devices in a wireless network, and to update the quality of service map using the received information.

29. A computer server according to claim 26 wherein the server also operates to communicate updated QoS maps to the mobile wireless devices.

30. A system comprising the server according to claim 26, comprising a wireless network and a plurality of mobile wireless devices in the coverage area of the network, wherein the mobile wireless devices each comprise a memory in which a quality of service map for the wireless network is persistently stored, the map comprises several layers of information visible at the same time, a first layer is a diagram showing physical features within the space where communications are provided by a service provider, additional layers indicate the value of respective quality of service metrics at locations indicated by the first layer; wherein, the user contracts with the communications service provider to have a selected level of communications services delivered to the mobile device, and wherein the user receives information from the map to enable provision of the selected level of communications services.

31. A software program installed on a mobile wireless device according to claim 17 to receive a quality of service map and communicate indications from them to the users, wherein the quality of service map comprises several layers of information visible at the same time, a first layer is a diagram showing physical features within the space where communications are provided by a service provider, additional layers indicate the value of respective quality of service metrics at locations indicated by the first layer; wherein, users of mobile wireless devices within the network contract with the service provider to have one or more selected communications services delivered to the mobile device; wherein the users also contract with the service provider to have the selected services provided at respective selected service levels; and wherein, the service provider, or the user, or both, use information from the map to enable provision of the selected communications services at the respective selected service levels.

32. A method for providing a quality of service map to a mobile wireless device, wherein the quality of service map comprises several layers of information visible at the same time, a first layer is a diagram showing physical features within the space where communications are provided by a service provider, additional layers indicate the value of respective quality of service metrics at locations indicated by the first layer; wherein, users of mobile wireless devices within the network contract with the service provider to have one or more selected communications services delivered to the mobile device; wherein the users also contract with the service provider to have the selected services provided at respective selected service levels; and wherein, the service provider, or the user, or both, use information from the map to enable provision of the selected communications services at the respective selected service levels; and providing the quality of service map according to claim 17 and further comprising the steps of:
receiving and storing information about at least one quality of service metric from mobile wireless devices at multiple locations within a wireless network coverage area;
creating and storing the map from the stored information;
transmitting the QoS map to mobile wireless devices in the coverage area of the network.

33. A method according to claim 32, wherein the step of creating a quality of service map is performed by a processor that applies machine learning techniques to the stored information to determine the quality of service at locations within the coverage area where a quality of service measurement is not stored.
